(19) United States
(12) Patent Application Publication
(10) Pub. No.: US 2026/0356008 A1
(43) Pub. Date: Nov. 12, 2026

(54) DEHUMIDIFICATION APPARATUS AND METHOD

(71) Applicant: PIOVAN S.P.A., Santa Maria di Sala (VE) (IT)

(72) Inventors: Enrico BELLIO, Ponzano Veneto (IT); Davide CAPPELLINI, Soncino (IT); Marco BORTOLOZZO, Salzano (IT)

(73) Assignee: PIOVAN S.P.A., Santa Maria di Sala (VE) (IT)

(21) Appl. No.: 19/116,541

(22) PCT Filed: Dec. 6, 2023
(86) PCT No.: PCT/IB2023/062318

§ 371 Date: Mar. 28, 2025

(30) Foreign Application Priority Data
Dec. 23, 2022 (IT) 102022000026736

(51) Int. Cl. B29B 13/06; F26B 3/06; F26B 3/34; F26B 3/347; F26B 17/14

(52) U.S. Cl. CPC B29B 13/065; F26B 3/06; F26B 3/343; F26B 3/347; F26B 17/1408

(57) ABSTRACT

A dehumidification apparatus includes at least one container for containing incoherent plastics, at least one conduit with at least one opening for introducing a process gas into the container, and a heating device with at least one electrode connected to a radiofrequency generator, the electrode being arranged at a distance from a conduit portion and being surrounded by the incoherent plastics.

### BACKGROUND OF THE INVENTION

The invention relates to a dehumidification method and/or apparatus, in particular for dehumidifying incoherent plastics, i.e. plastics in the form of particles like, for example, granules and/or microgranules and/or pellets and/or powder and/or flakes or the like. The invention in question can be suitable, in particular, for reducing the humidity content in particles of plastics.

Specifically, but not exclusively, the invention can be applied in the context of a plant for treating incoherent plastics, like, for example, a plant for dehumidifying and/or drying and/or crystallizing and/or packaging and/or conveying in a vacuum and/or under pressure the incoherent plastics. This plant can be intended, in particular, to supply a user machine, like, for example, a machine for processing and transforming plastics, in particular an extruder that supplies the extruded plastics to an injection-moulding and/or blow-moulding and/or compression-moulding apparatus.

In the sector of transforming plastics into a finished product, dehumidifying plastics into particles (polymer granules) before subjecting the plastics to the extruding and moulding process is known, to ensure the quality of the molded product, in particular for plastics with great hygroscopic properties, for example polyethylene terephthalate (PET), polyamide (PA), polycarbonate (PC)-based plastics, or some copolymer-based plastics like acrylonitrile butadiene styrene (ABS). In general, the polymer granule is dried and/or dehumidified in a hopper into which a continuous flow of dry and/or dehumidified hot air is delivered. The polymer granule that exits the hopper dried and/or dehumidified may be carried in molten or semi-molten state, for example to be extruded and injected into a mould.

The prior art teaches dehumidifying incoherent plastics by radiating with radio frequency waves or with microwaves.

Patent publication U.S. 5,420,404 shows the use of radio-frequency waves for dehumidifying dielectric plastics, like for example hygroscopic resins of plastics in the form of pellets, by heating plastics in a continuous process inside a container in which the plastics descend by gravity and are traversed by a flow of pre-heated air.

Patent publication US 2008/0060212 A1 shows a process for drying plastics in granules by radiation with microwaves inside a hopper where the granules are conveyed by gravity. US 2008/0060212 A1 discloses an apparatus according to the preamble of claim 1 and a method according to the preamble of claim 15.

Nevertheless, different aspects of the prior art processes for drying and/or dehumidifying the polymer granule are improvable.

Firstly, it is desirable to stabilize and standardize the conditions of the polymer plastics that leave the hopper dried and/or dehumidified, so that these conditions (in particular, temperature and humidity) are those desired for the entire mass of the polymer plastics. This is complicated by various factors, for example by the considerable mass of plastics to be heated, or by the thermal gradient that is generated in a hopper between the surface and the heart of the granule.

Secondly, it is desirable to reduce energy consumption, distribute the heating energy homogeneously in the mass of the plastics, increase productivity and decrease the duration of the dehumidification process.

### SUMMARY OF THE INVENTION

One object of the invention is to make a solution available that is alternative to prior art solutions for dehumidifying incoherent plastics by using radio-frequency waves.

One object of the invention is to propose a solution that is suitable for overcoming one or more of the aforesaid limits and drawbacks of the prior art.

One advantage is to homogenize the temperature of the granule of plastics so as to reduce the thermal gradient between the surface and the heart of the granule.

One advantage is to homogenize the humidity of the granule of plastics so as to reduce the humidity gradient between the surface and the heart of the granule.

One advantage is to stabilize and standardize the conditions (in particular, temperature and humidity) of the processed plastics.

One advantage is to homogenize the conditions (in particular, temperature and humidity) desired for the entire mass of the processed plastics.

Other advantages are reducing the energy consumption and/or distributing homogeneously the heating energy in the mass of the plastics and/or increasing the productivity and/or decreasing the duration of the dehumidification process.

Such objects and advantages, and still others, are achieved by an apparatus and/or a plant and/or a method according to one or more of the claims set out below.

In one embodiment, a dehumidification apparatus comprises at least one container for incoherent plastics, at least one conduit with at least one opening for introducing a process gas into the incoherent plastics present in the container, and a heating device with at least one electrode connected to a radiofrequency generator, in which the electrode and a conduit portion are arranged at a reciprocal distance and in which the electrode is surrounded by (and in contact with) the incoherent plastics and also the conduit portion is surrounded by (and in contact with) the incoherent plastics. The electrode may be, in particular, a bar-shaped element, i.e. an element with a dimension (length) that is greater than the other two.

In one embodiment, a method for dehumidifying particles of solid plastics comprises the steps of feeding the plastics into a container in which the plastics move from an upper zone of the container to a lower zone of the container, of heating the plastics in the container by generating an oscillating magnetic field with radio-frequency waves that hit the plastics in the container (with the effect, in particular, of supplying energy even to the heart of each particle, heating the entire particle from the heart to the surface and with the result of transferring humidity from the heart to the surface of the particle) with a frequency comprised between 300 Khz and 300 Ghz (more in particular with a frequency comprised between 1 Mhz and 1 Ghz, or comprised between 1 Mhz and 100 Mhz, or comprised between 10 Mhz and 100 Mhz, or comprised between 1 Mhz and 50 Mhz, still more in particular with a frequency comprised between 10 Mhz and 50 Mhz), and of hitting the plastics in the container with a flow of process gas (with the effect of evacuating the humidity transferred to the surface), in particular with a process gas (for example, air) heated and/or dehumidified previously.

The oscillating radio-frequency magnetic field may be generated, in particular, by making use of at least one electrode that is immersed in and surrounded by (and in contact with) the plastics contained in the container (in particular with a bar-shaped electrode arranged offset with respect to a central axis of the container) so that a part of the plastics is interposed between the electrode and a central zone of the container (in particular, a central zone where at least one portion of a conduit for conveying the process gas is arranged) and another part of the plastics is interposed between the electrode and a peripheral zone of the container.

The process gas may be fed by at least one conduit (that is not configured to contain, in use, the plastics) configured to convey the process gas and comprising (in particular, at a lower outlet end of the conduit) at least one opening for introducing the process gas inside the container (in a process volume defined by at least one wall of the container and suitable for being filled with the plastics to be processed). The gas inlet opening is arranged, in particular, in a non-peripheral zone of the container (for example, in a central zone of the container or anyway in a zone nearer the centre of the container than the position of the electrode).

The conduit may comprise at least one conduit portion (that does not contain the plastics) arranged inside the container so as to be surrounded by (and be able to be in contact with) the plastics in the container. The conduit for conveying the gas is so configured that the flow of process gas along the conduit portion is directed from the top downwards until it reaches the opening through which the process gas comes into contact with the plastics in the process volume. The conduit portion is impermeable to the process gas. The gas inlet opening (opening comprising, for example, a diffuser cone) may be arranged, in particular, at a lower end of the conduit portion.

The conduit portion may be arranged, in particular, placed alongside the electrode and at a certain distance from the electrode, such that the space inside the container comprised between the conduit portion and the electrode is, in use, occupied by a part of the plastics. A distance (for example the minimum distance) between the electrode and the conduit portion may be comprised, in particular, between an eighth and a quarter of the inner cross section of the container (inner diameter for a cylindrical container) at the height of the container in which this distance is measured. The conduit portion may be arranged, in particular, in a vertical central zone inside the container. The longitudinal axis of the conduit portion and the longitudinal axis of the electrode may be arranged parallel to one another, for example in a vertical direction.

The electrode is connected to a radiofrequency generator that may be adjusted in power and/or in frequency (in particular by electronic and programmable control means) on the basis or one or more features of the plastics, in particular on the basis of the chemical composition. The radiofrequency generator may be connected to a number N of electrodes, where N may be comprised between 1 and 7 (1≤N≤7. It is however possible to use a number of electrodes N>7, for example 7<N≤13, or also N>13.

Each electrode may be bar-shaped. Each bar may extend longitudinally with a longitudinal axis arranged vertically. The electrodes may be, in particular, parallel to one another with a circumferential arrangement. The electrodes may be, in particular, angularly equidistant from one another around a vertical axis of the container (dehumidification hopper). This vertical axis of the container may, in particular, pass through a lower outlet of the container through which the plastics exit the process volume. The construction material of the electrodes may comprise, in particular, at least one metal like, for example, copper, aluminium, brass, special alloys, or also a combination of the aforesaid materials. The construction material of the conduit portion may comprise, in particular, an electrically conductive material, or anyway a non-dielectric material (for example metal material).

Each electrode may comprise, or may be provided with, or may be operationally associated with, at least one temperature sensor, configured in particular to detect a surface temperature of the sensor.

The length of the electrode bars (each with a longitudinal axis arranged vertically) may be chosen in function of the geometry of the container. The length of the electrode bars (each with a longitudinal axis arranged vertically) may be chosen according to the type of the processed plastics (for example the nature or chemical composition of the plastics resin). It is possible to use bars of different lengths (for example depending on the geometry of the container or on the type of processed plastics). It is, in particular, possible to use a different length for each bar, or to use two or more groups of bars in which each group of bars comprises two or more bars of the same length and the length of each group of bars is different from the length of the other group of bars or of the other groups of bars.

The particles of solid plastics that are processed may comprise, in particular, plastics (polymer resin in granules). The processed plastics may comprise one or more polymer resins included in in the following set: polyethylene terephthalate (PET), polyamide (PA), acrylonitrile butadiene styrene (ABS), polyphenylene sulphide (PPS), polystyrene (PS), polyvinylchloride (PVC), polysulfone (PSU), polymethylmethacrylate (PMMA). Further, the processed plastics may comprise, in particular, recycled polymeric plastics (PCR).

The radiofrequency generator may be configured, in particular, to emit radiation with frequency comprised between 300 Khz and 300 Ghz. More in particular, the radiofrequency generator may be configured to emit radiation with frequency comprised between 1 Mhz and 1 Ghz (i.e. 106-109 Hz), or comprised between 1 Mhz and 100 Mhz, or comprised between 10 Mhz and 100 Mhz, or comprised between 1 Mhz and 50 Mhz, or more in particular comprised between 10 Mhz and 50 Mhz). In one practical non-limiting embodiment, a generator has been used that is configurable selectively at 13.56 Mhz or 27.12 Mhz, although it is also possible to use other frequencies.

Each bar electrode may have different shapes and dimensions in function of the geometry of the container (dehumidification hopper) and/or in function of the process volume defined by the container.

Each electrode may be controlled (by programmable electronic control means comprising, for example, a central processing unit, a programmable logic controller, a microprocessor, etc) with a set point value of the power supplied to the electrode. Each electrode may be controlled with a maximum threshold value, which must not be exceeded, of the temperature of the surface of the electrode. Each electrode may be controlled with a set point value of the temperature of the surface of the electrode. Controlling each electrode enables a desired transfer of radio-frequency energy to the solid particles of polymer resin to be obtained. The power may be provided to the electrode continuously, or as trains of pulses to avoid localized overheating and/or plasticization of the plastics.

It is, in particular, possible for most or the whole of the length of each bar to be re-immersed into the plastics to improve the efficacy of the heating of the plastics with the power emitted by the radio frequency. The number of electrodes (bars) may be chosen on the basis of the volume of plastics that have to be treated and into which the electrodes are immersed. The arrangement, number and conformation of the electrodes may be chosen, in particular, so as to reduce the dead zones, i.e. the zones of the process volume (i.e. the inner volume of the container to which the plastics are fed) not affected by radio frequency, and at the same time so as to avoid zones of excessive overlaying of radiation emitted by the electrodes, to avoid accumulation of energy with the risk of degradation of the plastics.

The flow of the process gas may flow against the descending flow (descending by gravity) of the particles of solid plastics. The process gas may comprise dried air and/or dehumidified air and/or an inert gas (nitrogen or nitrate mixtures) or another gas that is suitable for reducing thermo-oxidative phenomena.

The process gas may be introduced into the process volume, in particular into the mass of plastics contained in the container (hopper), by a diffuser (for example a diffuser cone) arranged in a lower zone of the container (in particular a central zone) and spaced apart from a wall of the container that surrounds the diffuser and defines the process volume.

Heating by the joint action of radio frequency and process gas (in particular, process gas preheated to a temperature greater than 50 °C, or greater than 60 °C, greater than 70 °C, or greater than 80 °C) enables, compared with heating with a single technology, energy consumption to be reduced, treatment time to be reduced, the efficiency of humidity extraction to be increased.

The radiofrequency generator may be controlled, in particular, on the basis of the chemical and physical features of the processed plastics and of the process gas used (for example, on the basis of the dielectric constant of the non-homogeneous mixture of processed plastics and process gas, that may be determined, for example, by the Maxwell Garnett equation). For example, in the case of PET processed with air, it is possible to generate waves with radiofrequency comprised between 1 Mhz and 100 Mhz, or comprised between 10 Mhz and 50 Mhz, for example equal to 27.12 Mhz.

The radiofrequency generator may be controlled, in particular, on the basis of a container filling factor, i.e. a ratio between the volume actually occupied by the plastics in the container during the process (volume that may be controlled with control means of known type) and the maximum total volume available inside the container to contain the plastics.

It has been established that the radio frequency increases its heating efficiency in the heart of the granule if the granule has been preheated to a temperature greater than ambient temperature, for example if a PET granule has reached a temperature greater than 70 °C. An increase has also been established of the temperature of the process gas near the zone arranged around the emission electrode of the radio frequency.

In one embodiment, a dehumidification method comprises a first stage, in which the particles of plastics are heated in a first container (up to a given temperature) by a flow of process gas, and a second stage, in which the plastics, removed from the first container and introduced into a second container, is further heated by radio-frequency waves and a flow of process gas inside the second container.

The aforesaid two-stage dehumidification method (with radio-frequency heating in the second stage) may be used, in particular, for recycled polymer plastics (PCR plastics) or for other plastics that could be subjected to high-temperature treatment for a long period.

The aforesaid two-stage method with radio-frequency heating in the second stage may be used, in particular, to process the plastics at a relatively low temperature in the first stage (in particular, with a process gas at a temperature below the polymer degradation temperature, for example below 65 °C for polyolefins and below 120-140 °C for the PTE), obtaining a more attenuated level of dehumidification, and using the radio frequency in the second stage for more intense heating as far as the heart of the granule of plastics.

As said previously, it has been established that heating polymer granules with radio frequency enables the extraction of humidity from the granule to be speeded up significantly if the granule is already at a high temperature (in particular, by a preheating step performed in a first container arranged upstream of the second container where heating occurs with radio frequency), for example for PA and PET at a temperature comprised between 100 °C and 140 °C. In this case, the efficacy of evaporation and thus dehumidifying the granule becomes much greater than heating with process gas.

It has also been established that dehumidification by heating with radio frequency is particularly effective when the incoherent plastics to be processed have a high degree of humidity, i.e. the heating with radio frequency can be more effective than heating with a process gas when the polymer granule has a high degree of humidity.

In one embodiment, a dehumidification method comprises a first stage, in which the particles of plastics are heated in a first container by radio-frequency waves and are traversed by a flow of process gas, and a second stage, in which the already at least partially dehumidified plastics, removed from the first container and introduced into a second container, are dehumidified further by a flow of process gas inside the second container.

The aforesaid two-stage dehumidification method (with radio-frequency heating in the first stage) may be used, in particular, for polymer plastics to be processed that have high humidity.

It is thus possible to provide at least two embodiments of methods with two stages: a first embodiment in which a stage with radio frequency (with a flow of process gas) precedes a stage without radio frequency (with a flow of process gas); a second embodiment in which a stage with radio frequency (with a flow of process gas) follows a stage without radio frequency (with a flow of process gas).

Both for the first embodiment and for the second embodiment, a reduction has been established (comprised between 30% and 50%) of the dehumidification treatment time of the polymer resin with respect to a single-stage treatment.

It is possible to provide a dehumidification method that is analogous to the two-stage method cited above (one stage without radio frequency before or after a stage with radio frequency), but performed in this case inside the same container (dehumidification hopper) with a single plastics stage.

For this purpose, a container may comprise in its process volume two process zones, equal to two stages as disclosed above, by a particular conformation and arrangement or configuration of the electrodes, so as to perform heating with radio frequency RF differentiated into two or more zones at different heights of the process volume.

In particular, it is possible to activate heating with radio frequency RF only in an upper zone of the process volume, whilst the flow of the process gas traverses both the lower zone and the upper zone of the process volume, obtaining a process that is analogous to a two-stage process with a first stage in the upper zone with radio frequency and a second stage in the lower zone without radio frequency).

Or, it is possible to activate heating with radio frequency RF only in a lower zone of the process volume, whereas the flow of the process gas traverses both the lower zone and the upper zone of the process volume, obtaining a process that is analogous to a two-stage process with a first stage in the upper zone without radio frequency and a second stage in the lower zone with radio frequency.

The plastics, which are loaded from above, traverse first the upper zone of the process volume. If the plastics are very humid, they may be dehumidified with greater efficiency in the upper zone through the effect of the heating with radio frequency RF, or if they are less humid, they may be preheated in the upper zone through the effect of the flow of the process gas.

The process with two process zones in a single container may be performed, for example, by electrodes of relatively reduced length (or by electrodes of relatively great length but configured so as to operate upon command exclusively in a portion that is reduced and the length of which portion is selectable) so that the radio frequency emission is arranged, at will, in an upper zone of the process volume or in a lower zone of the process volume, so that it may be considered that there is a stage with radio frequency arranged in the zone of the process volume where the electrodes operate and a stage without radio frequency arranged in the zone of the process volume where the electrodes do not operate.

The arrangement of two process zones inside a single container enables a process analogous to a two-stage process to be performed also because of the fact that the plastics descend at a descent speed inside a container with a known geometry with a given passage section of the plastics, in which the passage section may be, in particular, variable stating from top to bottom and the descent speed of the plastics may be, in particular, also variable inside the container.

In general, the number N of electrodes for emitting the radio frequency may depend on the cross sections of the container (diameter of the hopper) where the dehumidification process occurs, to ensure even distribution of the energy supplied by the radio-frequency waves.

Each electrode may be of oblong shape (for example bar-shaped) arranged with a longitudinal axis parallel to an axis (in general, vertical) of a discharge port of the plastics on the bottom of the container. Each electrode may be fixed to a cover that closes above a process volume defined by the container and may be arranged entirely below the cover.

Each electrode may be of oblong shape with a straight cross section having a maximum dimension comprised between 5 mm (millimeters) and 200 mm, in particular comprised between 10 mm and 150 mm. This maximum dimension may be chosen in function of the power of the radio frequency to be emitted. In particular, each electrode may comprise a cylindrical bar with a diameter comprised between 5 mm and 200 mm, or comprised between 5 mm and 150 mm, or comprised between 10 mm and 200 mm, or comprised between 10 mm and 150 mm, or comprised between 10 mm and 60 mm.

Each electrode may be provided, in particular, with a temperature sensor, suitable in particular for detecting the surface temperature of the sensor. This sensor may comprise, in particular, an optic fiber sensor or other type of sensor configured so as not to be affected by the action of the electromagnetic field generated by the radio-frequency generator.

In one embodiment, it is possible to arrange a movement device for moving the plastics in the container, for example by a stirrer that remixes the plastics in the process volume and/or by a recirculating system that removes a part of the plastics from an outlet from the container and returns the plastics into an inlet of the container. The movement of the plastics in the container promotes uniform diffusion of energy, improving the efficacy of heating and dehumidification of the plastics. The movement device enables the efficiency of treatment to be increased in particular in the case of a batch-type process, that is particularly suitable above all for materials whose chemical-physical and mechanical features require the materials to be subjected to moderate temperature gradients or to be processed with reduced volumes of plastics to limit the thrust of the mass of plastics on the discharge port of the container.

### BRIEF DESCRIPTION OF THE DRAWINGS

The invention can be better comprised and implemented with reference to the attached drawings that illustrate some embodiments thereof by way of non-limiting example, in which:

FIG. 1 is a vertical elevation of a diagram of a first embodiment of a dehumidification apparatus for incoherent plastics, with a radio-frequency electrode made in accordance with the present invention;

FIG. 2 is a section of the dehumidification apparatus of FIG. 1 according to a horizontal section plane;

FIG. 3 is a diagram, in a vertical elevation, of a second embodiment of a dehumidification apparatus for incoherent plastics, with two radio-frequency electrodes, made in accordance with the present invention;

FIG. 4 is a section, according to a horizontal section plane, of the container of the dehumidification apparatus of FIG. 3;

FIG. 5 is a perspective view, sectioned along a plane of vertical section, of a third embodiment of a dehumidification apparatus made in accordance with the present invention, with three radio-frequency electrodes;

FIG. 6 shows a part of the apparatus of FIG. 5 that includes the electrodes for applying energy with radio-frequency waves;

FIG. 7 shows the non-sectioned apparatus of FIG. 5;

FIG. 8 is a section in a vertical elevation of a fourth embodiment of a dehumidification apparatus made in accordance with the present invention;

FIG. 9 is a perspective view, sectioned along a plane of vertical section, of the dehumidification apparatus of FIG. 8;

FIGS. 10 and 11 show two embodiments of double-stage dehumidification plants made in accordance with the present invention.

### DETAILED DESCRIPTION

For the sake of simplicity, identical elements of embodiments have been indicated by the same numbering.

With reference to the aforesaid figures, with 1 a dehumidification apparatus has been indicated overall that is usable, in particular, to dehumidify incoherent plastics, i.e. plastics in the form of particles like, for example, granules and/or microgranules and/or powder and/or flakes or the like. The dehumidification apparatus 1 may be suitable, in particular, for reducing the quantity of humidity present in granular plastics intended, in particular, to supply a user machine 2, like, for example a machine for processing and transforming plastics, in particular an extruder that supplies the extruded plastics to an injection-moulding and/or blow-moulding and/or compression-moulding apparatus.

The dehumidification apparatus 1 comprises at least one container 3 that defines a process volume configured to contain the incoherent plastics. The container 3 may comprise, in particular, a dehumidification hopper. The container 3 may comprise, in particular, at least one containing wall W that bounds the process volume. The containing wall W may comprise, in particular, at least one portion of cylindrical wall with vertical axis and at least one lower frustoconical portion. The containing wall W may be made, as in these embodiments, of electrically conductive material or anyway of non-dielectric material, in particular of metal like, for example, steel or stainless steel or special alloys suitable for contact with plastics like PET, PA, ABS, PPS, PS, PVC, PSU, PMMA, PCR, etc.

The container 3 may comprise, in particular, at least one plastics inlet 4 arranged above and at least one plastics outlet 5 arranged below. The container 3 may be configured, in particular, to permit a continuous flow of incoherent plastics (in particular, a descent of the plastics by gravity) from the plastics inlet 4 to the plastics outlet 5. The container 3 may comprise, in particular, a through vertical axis passing through the plastics outlet 5. The container 3 may be provided, in particular, with a feeding hopper H arranged above the container 3 to feed the plastics to the plastics inlet 4 through which plastics enter the process volume.

The dehumidification apparatus 1 comprises at least one conduit configured to convey a process gas to the incoherent plastics to be processed (before the process gas comes into contact with the incoherent plastics to be processed in the process volume). The container 3 may comprise, in particular, at least one conduit inlet 6 through which the conduit for conveying gas can enter the container 3.

The conduit for conveying gas may comprise, in particular, at least one opening 7 for introducing the process gas into the process volume. The opening 7 may comprise, in particular, a diffuser of the process gas (for example, a diffuser cone). The process gas is conveyed along the conduit to then exit the conduit through the opening 7 and then come into contact with the incoherent plastics contained in the process volume in the container 3. The conduit comprises at least one conduit portion 8 arranged inside the container 3 so as to be able to be immersed in and completely surrounded by the incoherent plastics that fill the process volume. The conduit portion 8 is impermeable to the process gas.

The conduit portion 8 may be arranged, in particular, in a central vertical zone inside the container 3. The opening 7 may be arranged, in particular, at a lower end of the conduit portion 8. The conduit portion 8 is configured, in particular, so as to convey a flow of process gas in a direction from top to bottom. The conduit for conveying the process gas is configured, in particular, so that the process gas flows into the conduit portion 8 with a flow directed from top to bottom until it reaches the opening 7. The conduit portion 8 may be, as in these embodiments, made of electrically conductive material or anyway of non-dielectric material (for example of metal material, in particular of steel or stainless steel or special alloys suitable for contact with plastics like PET, PA, ABS, PPS, PS, PVC, PSU, PMMA, PCR, etc. The conduit portion 8 may be made, in particular, of the same plastics as the container 3.

The container 3 comprises at least one gas outlet T through which the process gas that has processed the incoherent plastics can exit. The gas outlet T may be arranged, in particular, in an upper zone of the process volume.

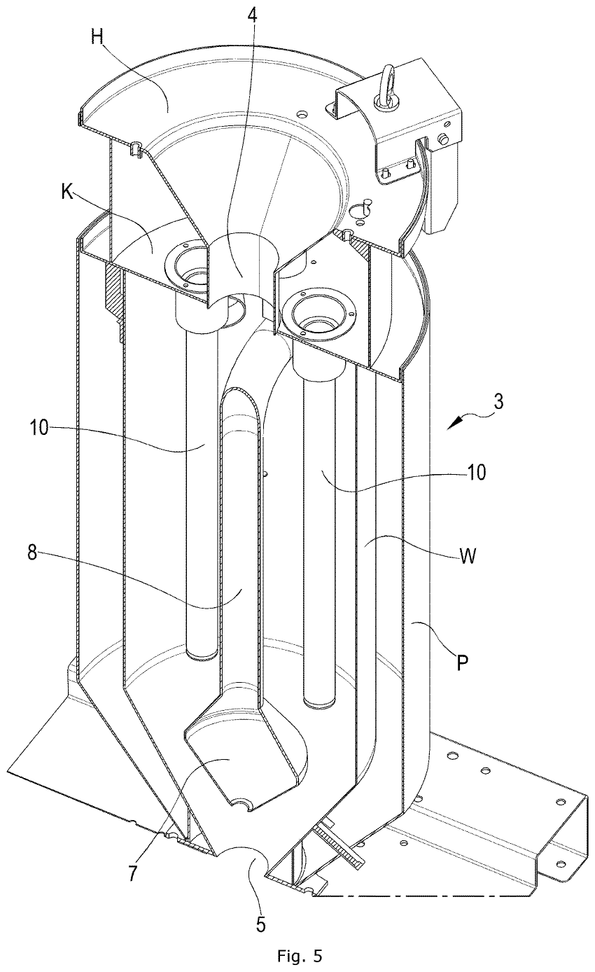

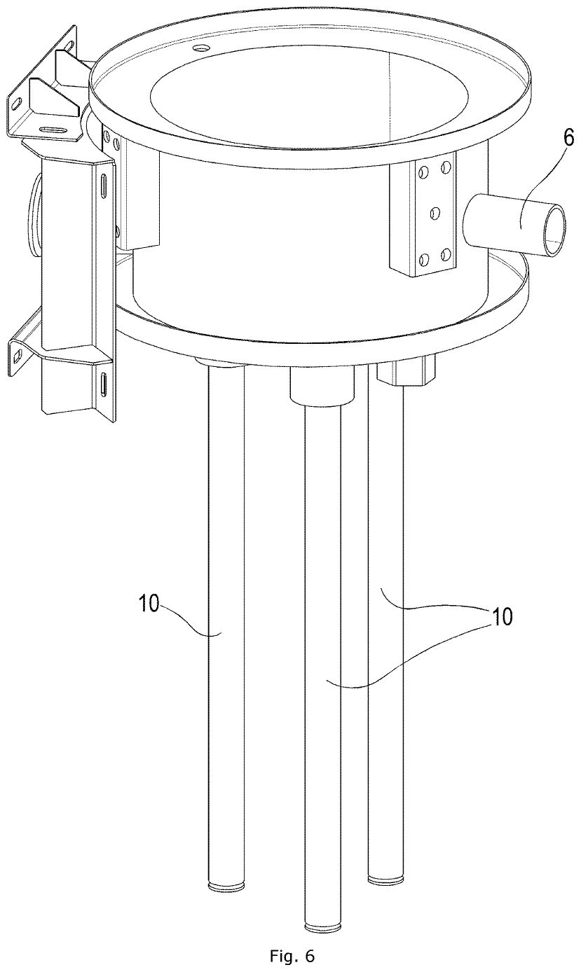

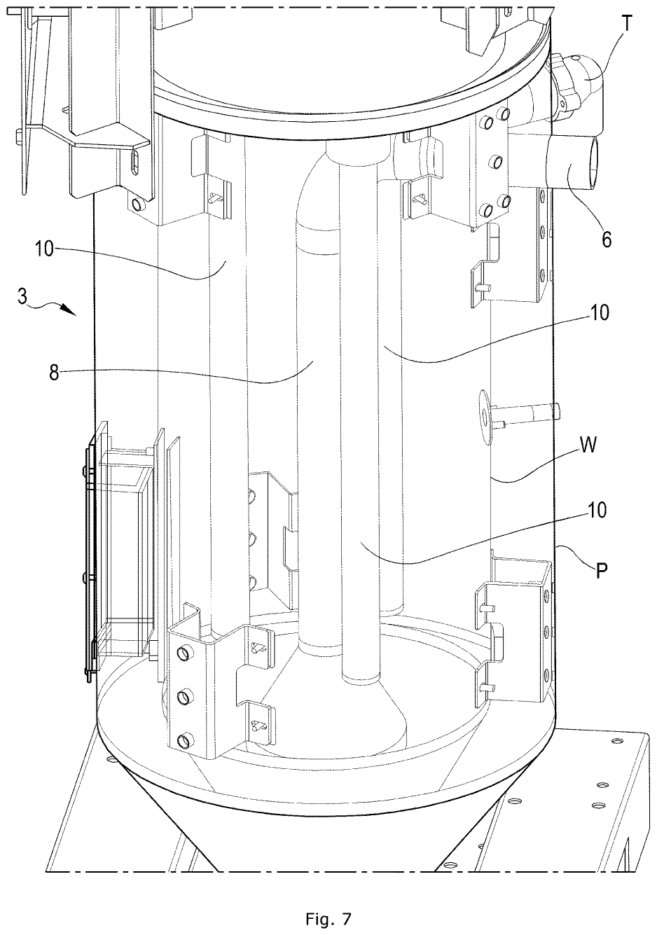

It is possible to provide, as in the specific embodiment of FIGS. 5-7, for the containing wall W to be impermeable to the incoherent plastics and permeable to the process gas (in particular, the containing wall W could be pierced). The containing wall W bounds internally a space to permit a flow of the process gas. The container 3 may comprise, in particular, a peripheral wall P that is impermeable to the process gas. The peripheral wall P may perform, in particular, an external insulating function. The wall P may comprise, in particular, an insulating layer.

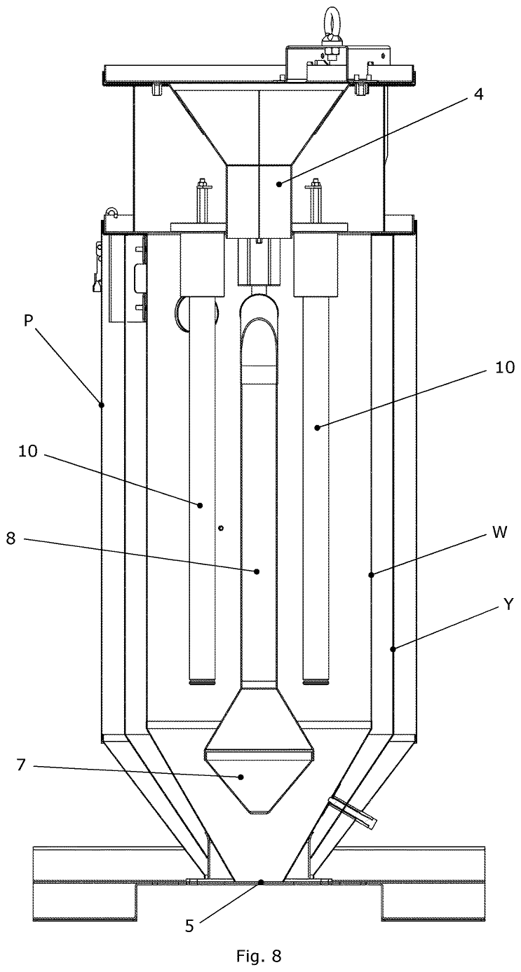

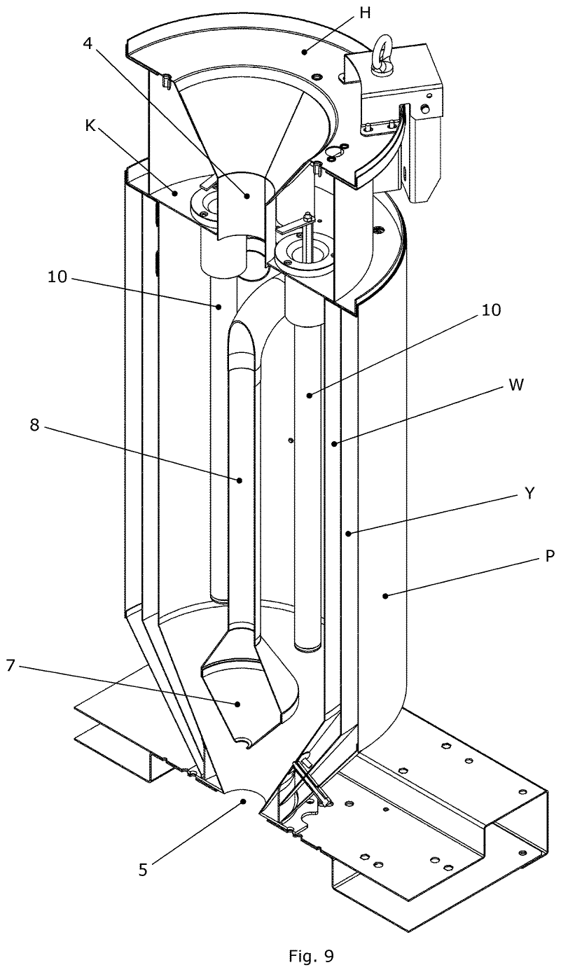

It is possible to provide, as in the embodiment of FIGS. 8-9, an intermediate wall Y that is interposed between the peripheral wall P and the containing wall W and that bounds externally the passage space of the flow of process gas. The intermediate wall Y may be arranged so as to surround at least partially the containing wall W and so as to define at least one annular space in which the transit of the process gas is possible.

In use, a part of the process gas can exit the process volume through the containing wall W to enter the annular space, with the possibility of returning to the process volume by passing again through the containing wall W, to then exit through the gas outlet T.

The dehumidification apparatus 1 comprises a heating device with at least one radiofrequency generator 9 and with at least one electrode 10 connected to the radiofrequency generator 9.

The electrode 10 is arranged inside the container 3 at a distance D from the conduit portion 8 so as to be able to be completely surrounded by the incoherent plastics that fill the process volume.

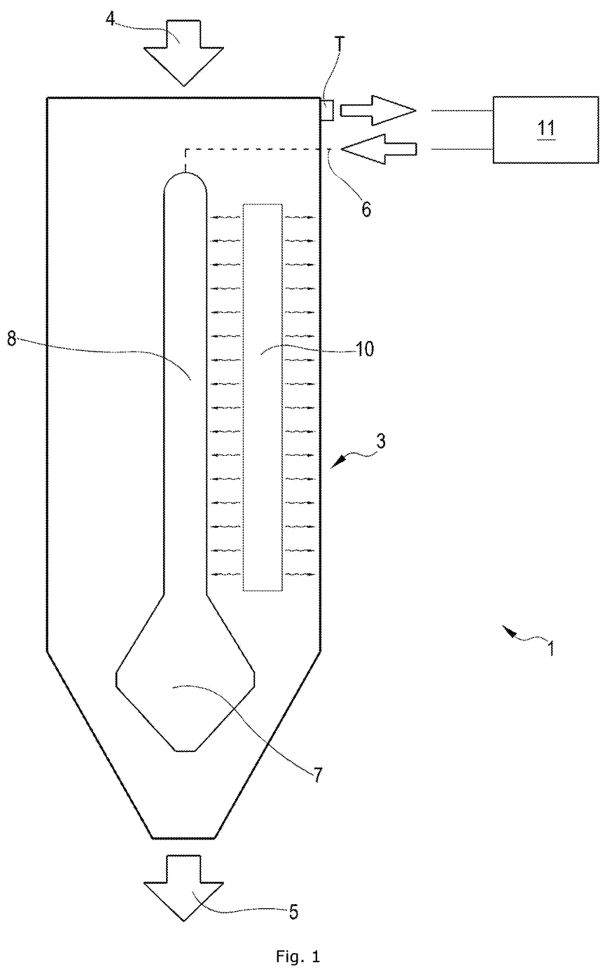

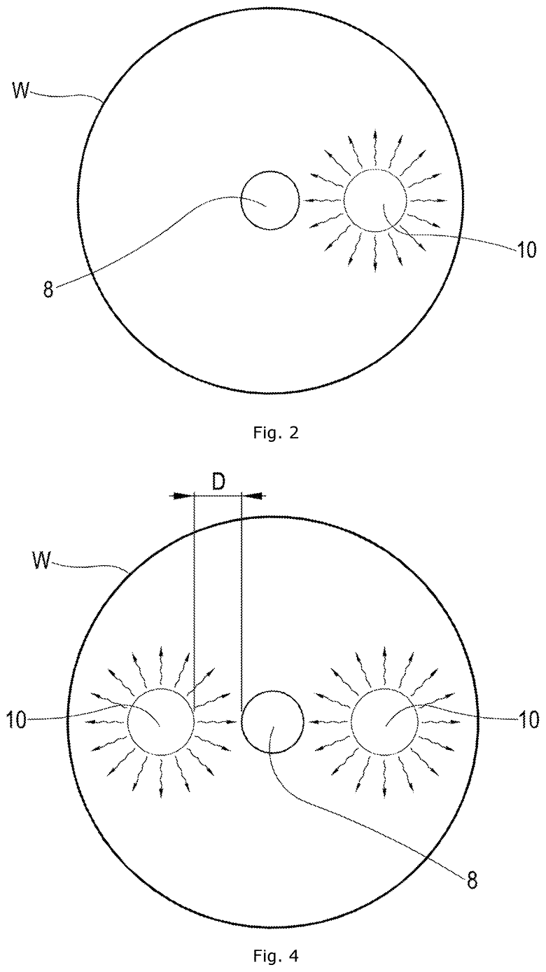

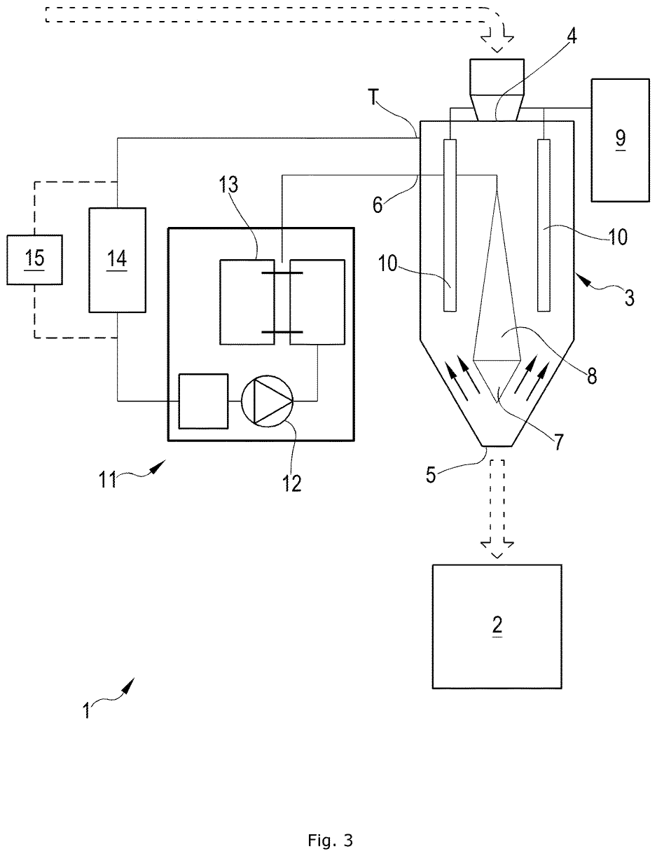

The attached figures show three dehumidification apparatuses that have been shown, merely by way of example, with an electrode 10 (FIGS. 1-2), with two electrodes 10 (FIGS. 3-4) and with three electrodes (FIGS. 5-7 and FIGS. 8-9), although the number N of electrodes may be different for each of the apparatuses shown (for example, N=1, or N=2, or N=3, or N=4, or N=5, or N=6, or N=7, or N>7, for each of the dehumidification apparatuses disclosed with reference to FIGS. 1-9).

Each electrode 10 may be arranged, in particular, at a height above the opening 7. Each electrode 10 may be arranged, in particular, alongside the conduit portion 8. Each electrode 10 may comprise, in particular, at least one portion of electrode placed alongside the conduit portion 8 and so shaped and arranged that each portion or segment or point of the portion of electrode situated at a certain vertical level is matched by a portion or segment or point of the conduit portion 8 situated at the same vertical level. Each electrode 10 may be, in particular, interposed between the conduit portion 8 and the containing wall W of the container 3. Each electrode 10 may be fixed to a cover K that closes the process volume above. Each electrode 10 may descend down from the cover K.

Each electrode 10 may be so arranged, in particular, in the container 3 that a part of the process volume, which can be filled with incoherent plastics, is interposed between the electrode 10 and the conduit portion 8. Each electrode 10 may be so arranged, in particular, in the container 3 that another part of the process volume, which can be filled with the incoherent plastics, is interposed between the electrode 10 and containing wall W.

Each electrode 10 may be, in particular, of oblong shape. Each electrode 10 may, in particular, extend along a longitudinal axis. The conduit portion 8 may extend, in particular, along a conduit axis parallel to the longitudinal axis. The longitudinal axis may be, in particular, arranged vertically. Each electrode 10 may comprise, in particular, at least one section that is orthogonal to the longitudinal axis with a maximum cross section comprised between 10 mm and 60 mm. The conduit portion 8, spaced apart from the electrode 10, may perform an earth electrode function. A distance D (minimum distance) between each electrode 10 and the conduit portion 8 may be comprised, in particular, between an eighth and a quarter of the inner diameter of the container 3.

The heating device may comprise, in particular, two or more electrodes 10 each of which is arranged in the container 3 so as to be able to be surrounded by the incoherent plastics that fills the process volume. The aforesaid two or more electrodes 10 may be arranged, in particular, circumferentially around the conduit portion 8. The aforesaid two or more electrodes 10 may be arranged, in particular, around a vertical conduit axis of the conduit portion 8 that are angularly spaced apart from one another.

The aforesaid two or more electrodes 10 may be so configured, in particular, that an area occupied by the aforesaid two or more electrodes 10 in a horizontal cross section of the process volume is comprised in a range from 1% to 6% of a total area of the horizontal cross section of the process volume, where total area means the area that can be occupied by the incoherent plastics, thus excluding at least one area occupied by the conduit portion 8. The aforesaid two or more electrodes 10 may be configured, in particular, so as to have at least one dimension that is different from one another, in particular a dimension (length) considered along a descent direction (substantially vertical direction) of the incoherent plastics.

The plastics inlet 4 may be arranged, in particular, at a level above the opening 7. The plastics inlet 4 may be arranged, in particular, at a level above the entire conduit portion 8. The plastics inlet 4 may be arranged, in particular, at a level above the entire electrode or at least a part of the electrode. The plastics outlet 5 may be arranged, in particular, at a level below the opening 7. The plastics outlet 5 may be arranged, in particular, at a level below the entire conduit portion 8. The plastics outlet 5 may be arranged, in particular, at a level below the entire electrode 10. The vertical axis of the container 3 may be, in particular, coaxial with the conduit axis of the conduit portion 8.

The process gas may be fed to the process volume 3 in a closed circuit or in an open circuit. The dehumidification apparatus 1 may comprise a treatment system 11 configured to treat the exhaust process gas exiting the process volume to generate a fresh process gas and then send the fresh process gas to a closed circuit, obtained from the treatment system 11, again in the process volume. The treatment system 11 may comprise, in particular, at least one actuator 12 (for example, a fan) to generate a flow of process gas in the closed circuit. The treatment system 11 may comprise, in particular, a dehumidification device 13 (for example, of the type with molecular screens, in particular with a double tower of molecular screens) for dehumidifying process gas before entering the process volume.

The treatment system 11 may comprise, in particular, a decontaminating device 14 to reduce the content of undesired volatile substances present in the process gas exiting the process volume. The decontaminating device 14 may comprise, in particular, a condensation system configured to condense substances (for example, volatile organic components) contained in the process gas and to evacuate the condensed liquid that has formed. The decontaminating device 14 may comprise, in particular, an active carbon filtration system configured to retain volatile substances (for example, volatile components not retained by the condensation system) contained in the process gas.

It is in particular possible to dispose of a monitoring system 15 that measures the content of one or more undesired substances (for example, total organic carbon) in the process gas upstream and/or downstream of the decontaminating device 14. The monitoring system 15 may be used, in particular, for feedback monitoring of one or more process parameters (for example, one or more process parameters that are suitable for increasing or decreasing the condensing power of the condensation system) on the basis of the measured values. The decontaminating device 14 may comprise both the condensation system and the active carbon filtration system, for example arranged serially one after the other.

The dehumidification apparatus 1 may comprise, in particular, at least one thermostat heater (not illustrated, for example a heater of known type) configured to heat the process gas so that it enters the container 3 at a desired temperature (above ambient temperature). The heater of the process gas may be arranged, in particular, between the dehumidification device 13 and the conduit inlet 6.

The dehumidification apparatus 1 may comprise, in particular, programmable electronic control means, connected to the sensors and to the actuators of the apparatus and configured to control the dehumidification process.

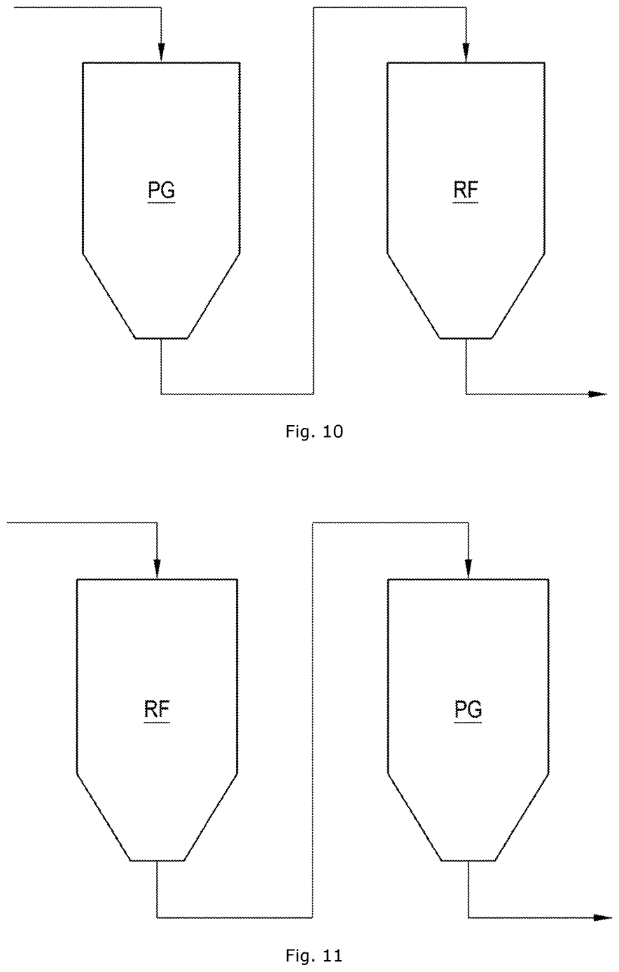

In FIGS. 10 and 11, two plants for dehumidifying incoherent plastics are shown schematically. Each plant comprises at least one dehumidifying stage with radio frequency RF and at least one dehumidifying stage with process gas PG connected to one another by an on-line (in particular, continuous) feeding system for feeding incoherent plastics.

The dehumidifying stage with radio frequency RF may comprise, in particular, a dehumidification apparatus configured to perform radio-frequency heating of the particles of solid plastics combined with treatment with process gas (in particular, previously heated and dehumidified process gas) that traverses the plastics, for example an apparatus like one of those disclosed above with reference to FIGS. 1 to 9.

The stage of dehumidification with process gas PG may comprise, in particular, a dehumidification apparatus configured to perform treatment with (previously heated and dehumidified) process gas that traverses the particles of solid plastics contained in a hopper (without heating particles of solid plastics with radio frequency).

The stage of dehumidification with process gas PG may comprise, in particular, a dehumidification apparatus, like one of those disclosed above, but devoid of the heating device with radio frequency, or provided with the heating device with radio frequency that is not however activated.

The stage of dehumidification with process gas PG may be arranged, in particular, so as to process the incoherent plastics before the dehumidifying stage with radio frequency RF (as in the embodiment of FIG. 10), or after the dehumidifying stage with radio frequency RF (as in the embodiment of FIG. 11).

In the embodiments of FIGS. 1-9, each electrode 10 extends in length approximately to about the lower end of the conduit portion 8, near the diffuser that has the opening 7, with an extent that is equal to about half the height of the cylindrical portion of the container 3. It is possible to provide other embodiments in which each electrode has a more limited extent and is arranged only in an upper zone of the process volume, or only in a lower zone of the process volume, forming a dehumidifying zone with radio frequency RF only in the upper zone or only in the lower zone of the process volume, so as to permit a sort of two-stage process in the environment of the same container. It is possible to provide embodiments with one or more “short” electrodes arranged only in the upper zone of the process volume and one or more “short” electrodes arranged only in the lower zone of the process volume, drivable selectively to generate radio frequency RF only in the upper zone, or only in the lower zone, or in both zones. It is possible to provide embodiments with one or more “long” electrodes extending both in the upper zone and in the lower zone of the process volume and one or more “short” electrodes arranged only in the upper zone of the process volume and/or one or more “short” electrodes arranged in the lower zone of the process volume, drivable selectively to generate radio frequency RF of greater or lesser amount in the upper zone and/or in the lower zone. It is possible to provide embodiments with one or more “long” electrodes each divided into two or more portions of electrode drivable selectively to generate radio frequency RF of different amount in different zones of the process volume.

A dehumidification method is provided that may be actuated, in particular, by making use of a dehumidification apparatus or a dehumidification plant as disclosed above.

The method comprises the step of introducing incoherent plastics to be dehumidified in a process volume defined by a container 3. The method comprises the step of introducing a process gas into the process volume through at least one opening 7 of at least one conduit for conveying the process gas. The conduit comprises at least one conduit portion 8 that is arranged inside the container and is completely surrounded by incoherent plastics that fill the process volume. The method comprises the step of emitting radio frequency waves by at least one electrode 10 arranged inside the container 3 at a distance D from the conduit portion 8. The electrode 10 is completely surrounded by the incoherent plastics that fill the process volume.

The method may comprise, in particular (see FIG. 10), before the step of introducing the incoherent plastics into the container 3, a preliminary step of heating and dehumidifying the incoherent plastics, in the dehumidifying stage with process gas PG that precedes the dehumidifying stage with radio frequency RF. This preliminary step may be achieved, in particular, inside a dehumidification hopper by a process gas. The method may comprise, in particular, the transferring step in which the processed plastics exiting the dehumidification hopper of the dehumidifying stage with process gas PG is transferred in line to the process volume of the dehumidifying stage with radio frequency RF. In this case, the incoherent plastics may comprise, in particular, recycled polymer plastics PCR, or other polymer plastics that have difficulty in withstanding high temperatures for a long time.

The method may comprise, in particular (see FIG. 11) a transferring step in which the processed plastics exiting the process volume of the dehumidifying stage with radio frequency RF are transferred to a dehumidification hopper of the dehumidifying stage with process gas PG where the incoherent plastics are dehumidified by a process gas. In this case, the incoherent plastics to be processed (first in the stage with radio frequency then in the stage without radio frequency) may comprise, in particular, plastics that have a relatively high humidity content, so that heating with radio frequency, which occurs in the first stage, is particularly effective without running the risk of damaging the plastics.

The method may comprise, in particular a step of controlling the emission of the radio frequency waves, in particular by controlling the radiofrequency generator 9, on the basis of one or more chemical-physical features of the incoherent plastics and/or of the process gas. The method may comprise, in particular, a step of controlling at least one feature of the process gas (for example, flowrate and/or the temperature and/or the humidity content) on the basis of one or more chemical-physical features of the incoherent plastics and/or of the process gas.

The aforesaid one or more chemical-physical features-on the basis of which the emission of the radio frequency waves and/or on the basis of which may be at least one feature of the process gas may be controlled-may be selected, in particular, from a set of features that includes: (1) a dielectric constant of a mixture of incoherent plastics and process gas and/or (2) a filling factor (i.e. a ratio between a volume actually occupied by the incoherent plastics in the container and a total volume available in the container for containing the incoherent plastics), and/or (3) a temperature of the incoherent plastics or a temperature of the process gas and/or (4) an indicative parameter of the humidity content in the incoherent plastics or a parameter indicating the humidity content in the process gas and/or (5) a chemical composition of the incoherent plastics.

In particular, the radiofrequency generator 9 may be controlled by the electronic control means (in power and/or in frequency) on the basis of the dielectric constant of the mixture of incoherent plastics and process gas used. The radiofrequency generator 9 may be controlled by the electronic control means (in power and/or in frequency) on the basis of the aforesaid filling factor. The radiofrequency generator 9 may be controlled by the electronic control means (in power and/or in frequency) on the basis of the chemical composition of the incoherent plastics.

1.-19. (canceled)

20. Dehumidification apparatus, comprising:
at least one container which defines a process volume configured to contain incoherent plastics;
at least one conduit configured to convey a process gas and comprising at least one opening for introducing the process gas into the process volume and at least one conduit portion which is impermeable to the process gas and is arranged inside the at least one container so that the at least one conduit portion can be surrounded by the incoherent plastics;
a heating device with at least one radiofrequency generator and with at least one electrode connected to the at least one radiofrequency generator, the at least one electrode being arranged inside the at least one container at a distance from the at least one conduit portion and so that the at least one electrode can be surrounded by the incoherent plastics. (New) Apparatus according to claim 20, wherein the at least one electrode comprises at least one electrode portion arranged alongside the at least one conduit portion in such a way that each portion of the at least one electrode portion is arranged at the same vertical level with respect to a corresponding portion of the at least one conduit portion.

22. Apparatus according to claim 20, wherein the at least one electrode is arranged at a higher level than the at least one opening.

23. Apparatus according to claim 20, wherein the at least one conduit portion is arranged in a central vertical zone inside the at least one container; the at least one opening being arranged at a lower end of the at least one conduit portion; the at least one opening comprising a process gas diffuser connected to the at least one conduit.

24. Apparatus according to claim 20, wherein the at least one container comprises at least one containing wall which bounds the process volume, the at least one electrode being interposed between the at least one conduit portion and the at least one containing wall; the at least one containing wall being made of electrically conductive material; the at least one conduit portion being made of electrically conductive material.

25. Apparatus according to claim 24, wherein the at least one electrode is arranged inside the at least one container so that a part of the process volume, which can be filled with the incoherent plastics, is interposed between the at least one electrode and the at least one conduit portion, and so that another part of the process volume, which can be filled with the incoherent plastics, is interposed between the at least one electrode and the containing wall.

26. Apparatus according to claim 20, wherein the at least one electrode is oblong in shape and extends along a longitudinal axis and wherein the at least one conduit portion extends along a conduit axis that is parallel to the longitudinal axis; the longitudinal axis being arranged vertically; the at least one electrode comprising at least one section which is orthogonal to the longitudinal axis and which has a maximum cross section between 10 mm and 60 mm; a minimum distance between the at least one electrode and the at least one conduit portion being comprised between one eighth and one quarter of a maximum diameter of the at least one container.

27. Apparatus according to claim 20, wherein the heating device comprises two or more electrodes, each of the two or more electrodes is arranged in the at least one container so as the each of the two or more electrodes can be surrounded by the incoherent plastics in the process volume, the two or more electrodes being arranged circumferentially around the at least one conduit portion around a vertical conduit axis; the two or more electrodes being configured in such a way that an area occupied by the two or more electrodes in a horizontal cross section of the process volume is included in a range from 1% to 6% of a total area of the horizontal cross section, where total area means the maximum area that can be occupied by the incoherent plastics, thus excluding at least an area occupied by the at least one conduit portion.

28. Apparatus according to claim 20, wherein the heating device comprises two or more electrodes, each of the two or more electrodes is arranged in the at least one container so as the each of the two or more electrodes can be surrounded by the incoherent plastics in the process volume; the two or more electrodes having different dimensions from each other, the dimensions being measured in a direction parallel to a conduit axis of the at least one conduit portion.

29. Apparatus according to claim 20, comprising at least one temperature sensor associated with the at least one electrode for detecting a surface temperature of the electrode.

30. Apparatus according to claim 20, comprising a movement device for moving the material in the container.

31. Apparatus according to claim 20, wherein the at least one container comprises at least one plastics inlet disposed at a level which is higher than the at least one opening and higher than the at least one conduit portion and higher than the at least one electrode, and wherein the at least one container comprises at least one plastics outlet arranged at a height which is lower than the at least one opening and lower than the at least one conduit portion and lower than the at least one electrode, the at least one container being configured to allow a flow of incoherent plastics from the at least one plastics inlet to the at least one plastics outlet; the at least one container comprising a vertical axis passing through the at least one plastics outlet and coaxial with a conduit axis of the at least one conduit portion.

32. Apparatus according to claim 20, comprising a controller configured to control the at least one radiofrequency generator on the basis of one or more chemical-physical features of the incoherent plastics and/or of the process gas, the one or more chemical-physical features comprising a dielectric constant of a mixture of incoherent plastics and process gas and/or a filling factor, i.e. a ratio between a volume actually occupied by the incoherent plastics in the container and a total volume available in the container to contain the incoherent plastics, and/or a temperature of the incoherent plastics or of the process gas and/or a parameter indicative of the moisture content in the incoherent plastics or in the process gas and/or the chemical composition of the incoherent plastics.

33. Plant for dehumidifying incoherent plastics, the plant comprising at least one dehumidifying stage with radiofrequency and at least one dehumidifying stage with process gas connected to each other with in-line supply of the incoherent plastics, the at least one dehumidifying stage with process gas being arranged so as to process the incoherent plastics before the at least one dehumidifying stage with radio frequency.

34. Plant according to claim 33, wherein the at least one radiofrequency dehumidifying stage comprises a dehumidification apparatus.

35. Dehumidification method, comprising the steps of:
introducing incoherent plastics to be dehumidified in a process volume defined by a container;
introducing process gas into the process volume through at least one opening of at least one conduit for conveying the process gas, the at least one conduit comprising at least one conduit portion arranged inside the container in which the process gas flows from top to bottom, the at least one conduit portion being surrounded by the incoherent plastics;
emitting radiofrequency waves by at least one electrode surrounded by the incoherent plastics, the at least one electrode being arranged at a distance from the at least one conduit portion.

36. Method according to claim 35, wherein the at least one electrode comprises at least one electrode portion arranged alongside the at least one conduit portion in such a way that each portion of the at least one electrode portion is arranged at the same vertical level with respect to a corresponding portion of the at least one conduit portion.

37. Method according to claim 34, comprising, before the step of introducing incoherent plastics, a preliminary step of heating and dehumidifying the incoherent plastics inside a dehumidification hopper by means of a process gas and a step of transferring the processed plastics leaving the dehumidification hopper in the process volume; the incoherent plastics comprising recycled polymeric plastics.

38. Method according to claim 34, comprising a step of transferring the processed plastics leaving the process volume to a dehumidification hopper inside which the incoherent plastics is dehumidified by a process gas.

39. Method according to claim 34, comprising a step of controlling the emission of radiofrequency waves by controlling a radiofrequency generator on the basis of one or more chemical-physical features of the incoherent plastics and/or of the process gas;
the one or more chemical-physical features comprising a dielectric constant of a mixture of incoherent plastics and process gas and/or a filling factor, i.e. a ratio between a volume actually occupied by the incoherent plastics in the container and a total volume available in the container to contain the incoherent plastics, and/or a temperature of the incoherent plastics or of the process gas and/or a parameter indicative of the moisture content in the incoherent plastics or in the gas process and/or the chemical composition of the incoherent plastics.
